(19) United States
(12) Patent Application Publication
(10) Pub. No.: US 2021/0299496 A1
(43) Pub. Date: Sep. 30, 2021

(54) Extinguishing Nozzle, Fire Extinguishing Installation and Fire Protection System with Energy Harvesting

(71) Applicant: Minimax GmbH & Co. KG, Bad Oldesloe (DE)

(72) Inventors: Joachim BÖKE, Bad Oldesloe (DE); André LICKEFETT, Bad Oldesloe (DE)

(21) Appl. No.: 17/262,194

(22) PCT Filed: Jul. 25, 2019
(86) PCT No.: PCT/EP2019/070102

§ 371 Date: Jan. 21, 2021

(30) Foreign Application Priority Data
Jul. 26, 2018 (DE) 10 2018 118 112.4

(51) Int. Cl. A62C 35/68; H02N 2/18

(52) U.S. Cl. CPC A62C 35/68; H02N 2/185

(57) ABSTRACT

The invention relates to an extinguishing nozzle of a fire extinguishing installation for selectively identifying and fighting fires in at least one protected area, and to an associated fire extinguishing installation and to a method for operating an extinguishing nozzle. The extinguishing nozzle comprises i) a communication unit which is configured for communicating with a fire detector and/or extinguishing control station of the fire extinguishing installation, ii) a control element which is configured for controlling the extinguishing nozzle, wherein the extinguishing nozzle is connectable to at least one fluid line and the control element is configured for selectively enabling and/or shutting off a passage of an extinguishing fluid, which is flowing in the fluid line, through the extinguishing nozzle, and iii) an energy harvester which is configured for providing energy for at least the communication unit and the control element by means of energy harvesting.

### PRIORITY CLAIM AND INCORPORATION BY REFERENCE

This application is a 35 U.S.C. § 371 application of International Application No. PCT/EP2019/070102, filed Jul. 25, 2019, which claims the benefit of German Application No. 10 2018 118 112.4 filed Jul. 26, 2018, each of which is incorporated by reference in its entirety.

### TECHNICAL FIELD

The following invention relates to an extinguishing nozzle of a fire extinguishing installation for selectively identifying and fighting fires in at least one protected area. The invention furthermore relates to a fire extinguishing installation that uses the extinguishing nozzle according to the invention, and to a fire extinguishing system. The invention likewise relates to a method for operating an extinguishing nozzle, and to an associated use.

### BACKGROUND AND SUMMARY OF THE INVENTION

The use of extinguishing nozzles in fire protection systems is known. To allow control of the triggering and/or communication with for example a fire detector and/or extinguishing control station, current-conducting connection lines must be laid to each of the extinguishing nozzles, which are generally provided in large numbers, in a particular protected area. These sprinkler systems with triggering arrangements controllable in this way are known for example from EP 2 286 879.

The connection by means of current-conducting cables however has numerous disadvantages. Firstly, faults may arise already during the laying of the lines, which faults later jeopardize the fail safety of the sprinkler system. Furthermore, the outlay is high and accordingly also associated with high costs. Simple alternative solutions, such as for example batteries, however fail simply owing to the associated maintenance outlay and environmental burden.

Against this background, it was an object of the present invention to specify extinguishing nozzles, fire protection installations and fire protection systems each having said extinguishing nozzles and also associated methods, which offer at least reduced installation and maintenance outlay.

According to a first aspect, the object is achieved by means of an extinguishing nozzle of a fire extinguishing installation for selectively identifying and fighting fires in at least one protected area. The extinguishing nozzle according to the first aspect has: i) a communication unit which is configured for communicating with a control unit of the fire extinguishing installation, ii) a control element which is configured for controlling the extinguishing nozzle, wherein the extinguishing nozzle is connectable to at least one fluid line and the control element is configured for selectively enabling and/or shutting off a passage of an extinguishing fluid, which is flowing in the fluid line, through the extinguishing nozzle, and iii) an energy harvester which is configured for providing energy for at least the communication unit and the control element by means of energy harvesting.

By virtue of the fact that the extinguishing nozzle according to this aspect has an energy harvester, it is not necessary for the extinguishing nozzle to be supplied with current or energy for example via electrical connection lines. Rather, the energy harvester is configured to provide energy harvested by means of energy harvesting. The communication unit and the control element can thus communicate, and control the extinguishing nozzle, without a complex process of installation of the extinguishing nozzle.

It is thus sufficient to install only the fluid lines by means of which the extinguishing fluid is conducted into the protected areas of the fire extinguishing installation, wherein the extinguishing nozzles attached or connected to the extinguishing lines offer reduced installation and maintenance outlay. Such extinguishing nozzles can then for example be exchanged easily and in an uncomplicated manner for maintenance purposes even without the need for the extinguishing nozzles to be separated from an electrical power supply network.

The fire extinguishing installation is configured for selectively identifying and fighting fires and fire sources. For this purpose, either the extinguishing nozzle itself or a further element of the fire extinguishing installation may have suitable sensor means which are configured for detecting fires and fire sources. It is crucial that, when a fire has been identified or a fire source has been identified, the extinguishing nozzle according to the invention can, by means of the communication unit, receive a corresponding triggering signal for enabling or shutting off the passage of the extinguishing fluid.

Energy harvesting is to be understood generally to mean the obtaining of electrical energy from all conceivable environmental sources, such as for example ambient temperature, vibrations or air flows. In the context of the extinguishing nozzle according to the invention, all technologies suitable for energy harvesting which provide a sufficient energy quantity that is required by the extinguishing nozzle are conceivable. A particular advantage of the solution according to the invention is accordingly that no external electrical cables or lines have to be provided for the purposes of supplying energy to the extinguishing nozzle.

The control element and other elements of the extinguishing nozzle may be arranged within or outside a housing of the extinguishing nozzle, that is to say a nozzle housing, as long as they form, together with the nozzle housing, a functional unit which performs the functions according to the invention.

The communication unit is preferably configured for bidirectional communication. It is thus also possible, for example, for the extinguishing nozzle to transmit information, such as information regarding a fire detected by the extinguishing nozzle itself, to the control unit of the fire extinguishing installation. For the operation of the extinguishing nozzle, that is to say for the reliable triggering of the extinguishing nozzle, it is however the case that only communication from the control unit in the direction of the communication unit of the extinguishing nozzle is required, that is to say, in the event of a selectively identified fire, the triggering of the extinguishing nozzle takes place by way of the communication proceeding from the control unit. In this case, unidirectional communication is also sufficient.

In a preferred embodiment, the energy harvester is configured to provide energy utilizing the piezoelectric effect, the thermoelectric effect, the electromagnetic effect, the photoelectric effect and/or from flow energy, in particular of the incident flow of air, for example in the form of wind generators, or of fluids, in the form of turbines. The energy harvester is preferably configured to utilize multiple effects alternatively or in combination.

The configurations of the energy harvesting and of the energy harvester may utilize macro effects or else, preferably, micro effects.

Micro effects are for example effects based on the piezoelectric effect which generate electrical voltages in the event of action of a force, for example as a result of pressure or vibration. Here, the energy harvesters can for example convert vibrational energy present in the environment into electrical energy, similarly to the principle of self-winding watches.

The thermoelectric effect, too, is a micro effect which utilizes the fact that an electrical voltage arises between ends of a metal tie rod when a temperature gradient prevails in the rod. Despite the low efficiency, thermoelectric generators have considerable advantages because they require no moving parts, are maintenance-free owing to the materials used, and make it possible to utilize natural heat sources or residual heat.

The utilization of the electromagnetic effect is known for example from passive RFIDs, which converts energy of electromagnetic radiation, for example of radio waves. Finally, in the case of the photoelectric effect being utilized, light energy, for example diffuse ambient illumination, is made utilizable directly for electrical consumers. For example, the energy harvester may have solar cells for converting light into electrical current.

In a preferred embodiment, the energy harvester is configured to receive and provide the energy from an energy transmitter which is provided for each protected area and which is configured for transmitting energy.

A protected area is for example a building section, such as a room, a hallway, a part of a hallway or the like. There are no limitations to the form and/or number of protected areas that are monitored by the fire extinguishing installation. An energy transmitter configured for transmitting energy for each protected area can be configured energy utilizing one or more of the possible effects that make energy harvesting possible. For example, the energy transmitter may emit electromagnetic radiation, for example radio waves, targeted heat or else light. The energy transmitter may, for this purpose, either be configured targetedly for one or more extinguishing nozzles of the protected area, or have an untargeted effect on a relatively large number of extinguishing nozzles. The energy transmitter may however also introduce energy in targeted fashion into the fluid line and/or the extinguishing fluid flowing therein. This may for example, if a fluid flowing in the fluid line is conductive, be an electrical current, though an increase in temperature of the extinguishing fluid and/or a utilizable flow of the extinguishing fluid through the fluid line are also conceivable.

By virtue of the fact that the energy harvester can receive the dedicated energy of the energy transmitter, higher power consumption of the communication unit and/or of the control element is possible. The energy obtained by means of the energy harvester is specifically not only restricted by the ambient energy, but is increased as a result of the combination with the energy quantity introduced from the energy transmitter. It is for example possible in this way, without limitation to this, for higher voltages to be generated in the energy harvester, which can allow lower currents.

In a preferred embodiment, the energy harvester has a piezo element.

In this way, it is possible in particular for vibrations that act on the energy harvester to be converted into electrical current. Also, in another embodiment, the piezo element may be configured to generate electrical voltages as a result of pressures and/or changes in pressure, for example also manually.

In one preferred embodiment, the energy harvester is configured to utilize a pressure or a change in the pressure within the fluid line for the purposes of providing energy.

For this embodiment, too, the energy harvester preferably has a piezo element which is arranged outside or within the fluid line. Pressures or changes in pressure within the fluid line can be detected in a particularly advantageous manner if the piezo element is in almost direct contact with the fluid. In this way, the pressures or changes in pressure are transmitted preferably without attenuation to the energy harvester for the purposes of energy conversion.

In one preferred embodiment, the energy harvester is configured to utilize a temperature or a flow through the fluid line for the purposes of providing energy.

This preferred embodiment is suitable in particular if a continuous flow through the fluid line or a regular flow through the fluid line is required. If flow necessarily passes through the fluid line for example for the purposes of allowing a cyclic exchange of the extinguishing fluid, this throughflow is suitable for conversion into energy by the energy harvester. An elevated temperature of the extinguishing fluid, for example in relation to the surroundings, or else conversely a lower temperature of the extinguishing fluid in relation to the surroundings, is likewise advantageously suitable for conversion by means of the energy harvester in further preferred embodiments.

In one preferred embodiment, the energy harvester is configured to provide an electrical current, which is conducted by means of a fluid arranged within the fluid line, as energy.

In the case that the extinguishing fluid has suitable conductivity, current can be conducted directly via the extinguishing fluid. For example, electrical currents, in particular alternating currents, can also be detected at the extinguishing nozzle and converted by means of the energy harvester.

In one preferred embodiment, the energy harvester implements at least two different forms of energy harvesting.

By virtue of the fact that at least two different forms of energy harvesting are implemented, the extinguishing nozzle according to the invention is designed to reliably supply current to the communication unit and/or to the control element even in the event that one of the two energy sources fails. Operational reliability and fail safety are thereby increased.

In one preferred embodiment, the extinguishing nozzle furthermore has an energy store which is configured to buffer-store energy provided by the energy harvester, wherein a capacity of the energy store is configured such that, in the event of failure of the energy harvesting, reliable operation is ensured until the in particular wireless transmission of energy has been restored.

By virtue of the fact that the capacity of the energy store bridges at least a time until the restoration of the energy harvesting, continuous operation without interruptions of the extinguishing nozzle is ensured. In particular, even in the event of a failure of the energy harvesting, for example as a result of failure of the energy harvester or else as a result of an outage of provided, for example wirelessly transmitted energy, sufficient time remains available, for example for maintenance and exchange. The communication unit is preferably configured to communicate the failure. The duration that can be bridged by means of the energy store may self-evidently be coordinated with the requirements of the actual application. For operational reliability, it is preferable for multiple redundant communication paths, and/or multiplexing of the communication, to be provided.

In a further preferred embodiment, the extinguishing nozzle has a controllable triggering arrangement with a housing and with a shut-off valve which is arranged in said housing and which is sealed off by means of a sealing element.

For example, the sealing element of this or other preferred embodiments has a sealing plate spring which presses against the shut-off valve. Other suitable sealing elements may self-evidently advantageously also be used.

The shut-off valve is, in one embodiment, in the form of a solenoid valve and/or a piezo valve and is equipped with outputs for connection to the energy store in conjunction with the control element.

Alternatively or in addition, in one preferred embodiment, the controllable triggering arrangement has a temperature-sensitive, destructible probe element. The temperature-sensitive destructible probe element is coupled to a thermal heating element, and the heating element is equipped with outputs for connection to the energy store in conjunction with the control element.

By actuation of the thermal heating element with the energy stored in the energy store, the destructible probe element is warmed such that it releases the extinguishing fluid and thus effects the triggering of the extinguishing nozzle. This type of controllable triggering permits particularly reliable triggering which is implemented with little energy usage. Other forms of triggering arrangement, for example mechanical valves, are self-evidently also conceivable alternatively or in combination.

According to a second aspect, the object is achieved by means of a fire extinguishing installation for selectively identifying and fighting fires in at least one protected area. The fire extinguishing installation has, for each protected area, one or more extinguishing nozzles according to the first aspect and furthermore has, for each protected area, an energy transmitter which is configured for transmitting energy to the one or more extinguishing nozzles.

All of the advantages described for the extinguishing nozzle according to the first aspect can be attained with the fire extinguishing installation according to the second aspect. In particular, the fire extinguishing installation can advantageously be combined with all of the embodiments described above as being preferred.

Since the fire extinguishing installation has, for each protected area, an energy transmitter which is configured for transmitting energy, a reliable supply of energy to the one or more extinguishing nozzles is ensured. All conceivable suitable energy transmitters, which are preferably of wireless configuration, may be used here. The splitting-up of the fire extinguishing installation in the protected area makes it possible, for example, for triggering of the extinguishing nozzles to be possible selectively for one or more protected areas. It is accordingly preferably the case that the extinguishing nozzles for a protected area are triggered jointly. If selective triggering, for example restricted to particular areas, is desired, then multiple protected areas must be provided. This further simplifies the installation. For example, reliable extinguishing within a protected area can be implemented by means of a single control command.

In one preferred embodiment, the energy transmitter has a communication connection to the fire detector and/or extinguishing control station and is configured to communicate with the one or more extinguishing nozzles, wherein the communication of the extinguishing nozzles with the fire detector and/or extinguishing control station takes place via the energy transmitter.

Accordingly, in this embodiment, the energy transmitter constitutes the interface between fire detector and/or extinguishing control station and extinguishing nozzle. The energy transmitter can accordingly communicate simultaneously with the extinguishing nozzles and with the fire detector and/or extinguishing control station. Preferably, the communication between extinguishing nozzles and energy transmitter is configured to be bidirectional, that is to say communication is made possible both from the energy transmitter to the extinguishing nozzle and vice versa. Accordingly, the energy transmitter is preferably configured to receive commands from the fire detector and/or extinguishing control station and transmit said commands to the extinguishing nozzle, and to simultaneously also receive measurement signals or detection signals, which have been received for example by sensor means arranged in the extinguishing nozzles, via the same communication channel from the extinguishing nozzle. Alternatively or in addition to sensors arranged at the extinguishing nozzles, the fire extinguishing installation is also configured to receive for example autonomously or separately operating sensors, which likewise communicate their detection signals directly to the fire detector and/or extinguishing control station or to the energy transmitter.

In one preferred embodiment, the energy transmitter is configured to overlay or superimpose the communication with an energy receiver onto the transmitted energy.

By virtue of the communication being overlaid or superimposed onto the transmitted energy, it is possible for one and the same communication channel, that is to say the energy that is to be transmitted in any case, to be supplemented by a further function. This leads to a low level of overall complexity. In particular, it is specifically then not necessary for a further dedicated communication channel to be provided in addition to the energy transmission channel.

In one preferred embodiment, the transmitted energy comprises electromagnetic energy in the form of a targeted light beam or of some other targeted electromagnetic pulse.

A targeted light beam or some other targeted electromagnetic pulse is a particularly effective form of transmission of energy from the energy transmitter to the extinguishing nozzle. Furthermore, targeted light beams or electromagnetic pulses are also suitable, by way of modulations, for example frequency or amplitude modulations, for carrying communication signals via the same channel.

In one preferred embodiment, the fire extinguishing installation furthermore comprises at least one fluid line for providing extinguishing fluid at the one or more extinguishing nozzles, wherein the fluid line is electrically insulated, and the energy harvester is configured to provide electrical energy transmitted by means of an electrically conductive fluid within the fluid line.

The fluid line, which is configured such that the extinguishing fluid for the purposes of fighting fires flows through, is required for ensuring fire protection in the context of fire protection systems. By virtue of the fact that, to harvest electrical energy, the energy harvester uses an electrically conductive fluid that is arranged within the fluid line, the typically required fluid line is supplemented by an additional function, specifically that of transmitting energy. In this way, the additional outlay for cabling, for example if electrical cables were required for transmitting energy, is eliminated.

In one preferred embodiment, the activation of the extinguishing nozzles takes place automatically in the event of a communication failure.

By virtue of the fact that the activation of the extinguishing nozzles takes place automatically in the event of a communication failure, it is ensured that effective firefighting is not prevented owing to a failure of the communication between extinguishing nozzle and energy transmitter. Preferably, a threshold value, for example a particular period of time, may be provided, which is configured for the restoration of the communication. If the communication cannot be restored within this threshold value, the activation of the extinguishing nozzles takes place automatically. The period of time for the triggering delay must be adapted to the individual situation and is dependent inter alia on potential fire risks in the protected area.

According to a third aspect, the object is achieved by means of a fire extinguishing system having a fire extinguishing installation according to the second aspect and having a fire detector and/or extinguishing control station.

According to a fourth aspect, the object is achieved by means of a method for operating an extinguishing nozzle of a fire extinguishing installation for selectively identifying and fighting fires in at least one protected area. The extinguishing nozzle has: i) a communication unit which is configured for communicating with a fire detector and/or extinguishing control station of the fire extinguishing installation, ii) a control element which is configured for controlling the extinguishing nozzle, wherein the extinguishing nozzle is connectable to at least one fluid line and the control element is configured for selectively enabling and/or shutting off a passage of an extinguishing fluid, which is flowing in the fluid line, through the extinguishing nozzle, and iii) an energy harvester which is configured for providing energy for at least the communication unit and the control element by means of energy harvesting. The method comprises a provision of energy by the energy harvester by means of energy harvesting.

In one preferred embodiment, the method comprises a transmission of energy to the energy harvester of the extinguishing nozzle by means of an energy transmitter.

According to a fifth aspect, the object is achieved through the use of a fluid situated in a sprinkler conduit for the purposes of transmitting energy.

The fire extinguishing system according to the third aspect, the method according to the fourth aspect and the use according to the fifth aspect also allow the same advantageous effects that have been described for the first and second aspect of the invention. Combinations of the fire extinguishing system according to the invention, of the method according to the invention and of the use according to the invention with all embodiments of the first and second aspect described as being preferred can likewise be advantageously implemented.

Fire extinguishing installations with extinguishing fluid lines for conducting an extinguishing fluid are basically known. The fire extinguishing installation generally comprises one, two or more extinguishing devices, in particular sprinklers and/or extinguishing nozzles. The extinguishing devices are, in modern systems, often electrically coupled to further components of the fire extinguishing installation and/or further devices of a fire protection system. The coupling firstly allows the supply of electrical energy to components of the fire extinguishing installation, and furthermore allows the transmitting and receiving of signals.

As mentioned, the connection by means of current-conducting and/or signal-conducting cables however has numerous disadvantages. Firstly, faults may arise already during the laying of the cables, which faults are often detectable for the first time in the event of a fire and thus jeopardize the fail safety of the sprinkler installation. Simple alternative solutions, such as for example batteries and/or storage batteries, fail owing to the associated maintenance outlay, because it is commonly possible, in large installations, for several dozen or even several hundred sprinklers and/or extinguishing nozzles to be provided.

Against this background, it is likewise an object of the present invention to provide a fire extinguishing installation, a fire protection system and a method which alleviate or eliminate one or more of the disadvantages mentioned above. It is furthermore an object of the present invention to provide a solution which offers reduced installation and/or maintenance outlay.

In a further aspect, there is accordingly proposed a fire extinguishing installation, in particular for selectively identifying and/or fighting fires in at least one protected area. The fire extinguishing installation comprises an extinguishing fluid line for conducting an extinguishing fluid, wherein an extinguishing device, in particular a sprinkler and/or an extinguishing nozzle, is arranged on the extinguishing fluid line, and wherein the extinguishing fluid line is arranged and designed to conduct electrical energy to the extinguishing device.

Preferably, the extinguishing device is in the form of a sprinkler and has at least one control unit, wherein the sprinkler has at least one extinguishing fluid inlet and at least one extinguishing fluid outlet with a fluidic connection running between these, preferably two or more extinguishing fluid outlets, wherein the extinguishing fluid outlet is assigned one of the control units for selectively enabling or shutting off the fluidic connection between extinguishing fluid inlet and extinguishing fluid outlet, and wherein the control unit is electrically coupled to the extinguishing fluid line.

The sprinkler preferably has at least one sensor device, wherein the sensor device is configured to detect a fire source and is in particular configured to localize the fire source, and wherein the sensor device is electrically coupled to the extinguishing fluid line.

The extinguishing device preferably comprises a communication unit which is configured for communicating with a control device, preferably a fire detector and/or extinguishing control station, and wherein the communication unit is arranged and designed to communicate with the control device via the extinguishing fluid line.

The fire extinguishing installation preferably comprises an energy coupling device which is arranged and designed to electrically couple the extinguishing fluid line to a) the extinguishing device, and/or b) the sensor device, and/or c) the communication unit, and wherein the energy coupling device is preferably arranged on the extinguishing device.

The extinguishing fluid line is preferably electrically couplable to an energy source.

The extinguishing fluid line is preferably formed by a line conduit, wherein, furthermore, the line conduit is composed of an electrically conductive material or comprises an electrically conductive material, and/or the line conduit is arranged and designed such that electrical energy can be caused to flow through the line conduit.

The extinguishing fluid line preferably has a conductive layer, in particular a conductive coating, wherein the conductive layer is composed of an electrically conductive material or comprises an electrically conductive material, and wherein the conductive layer is arranged on an outer circumferential surface and/or an inner circumferential surface of the line conduit, wherein the extinguishing fluid line is arranged and designed to conduct electrical energy through the conductive layer to the extinguishing device, and wherein the line conduit is preferably composed of, or comprises, substantially electrically non-conductive material.

The extinguishing fluid line preferably has an insulating layer, in particular an insulating coating, and the conductive layer, wherein the conductive layer is arranged between the line conduit and the insulating layer in a radial direction of the extinguishing fluid line, and wherein, preferably, the insulating layer is arranged to the inside of the line conduit in a radial direction and/or, preferably, the insulating layer is arranged to the outside of the line conduit in a radial direction.

The extinguishing fluid line is preferably arranged and designed to conduct electrical energy within an extinguishing fluid situated in the extinguishing fluid line.

The fire extinguishing installation preferably comprises an energy infeed device which is configured to feed electrical energy into an extinguishing fluid situated in the extinguishing fluid line.

The fire extinguishing installation preferably comprises two or more extinguishing fluid lines for conducting an extinguishing fluid, and/or two or more extinguishing devices which are arranged on the extinguishing fluid line or on the two or more extinguishing fluid lines.

In a further aspect, a fire protection system is proposed, comprising a fire extinguishing installation conforming to the fire extinguishing installation according to the above aspect or to a preferred configuration, an extinguishing fluid source, in particular an extinguishing fluid tank, preferably a compressed-air water tank, and an extinguishing fluid pump.

In a further aspect, a method for operating a firefighting installation in particular for selectively identifying and/or fighting fires in at least one protected area is proposed, comprising conducting an extinguishing fluid in an extinguishing fluid line with an extinguishing device, conducting electrical energy through the extinguishing fluid line, and preferably operating an extinguishing device, and/or a sensor device, and/or a communication unit.

### BRIEF DESCRIPTION OF THE DRAWINGS

Further advantages and configurations will be described below with reference to the appended figures, in which:

FIG. 1 shows, schematically and by way of example, a fire extinguishing installation according to the invention;

FIG. 2 shows, schematically and by way of example, an extinguishing nozzle according to the invention;

FIG. 3 shows, schematically and by way of example, a fire extinguishing installation;

FIG. 4 shows, schematically and by way of example, a cross section of a fluid line;

FIG. 5 shows, schematically and by way of example, a cross section of a fluid line; and

FIG. 6 shows, schematically and by way of example, a cross section of a fluid line.

### MODE(S) FOR CARRYING OUT THE INVENTION

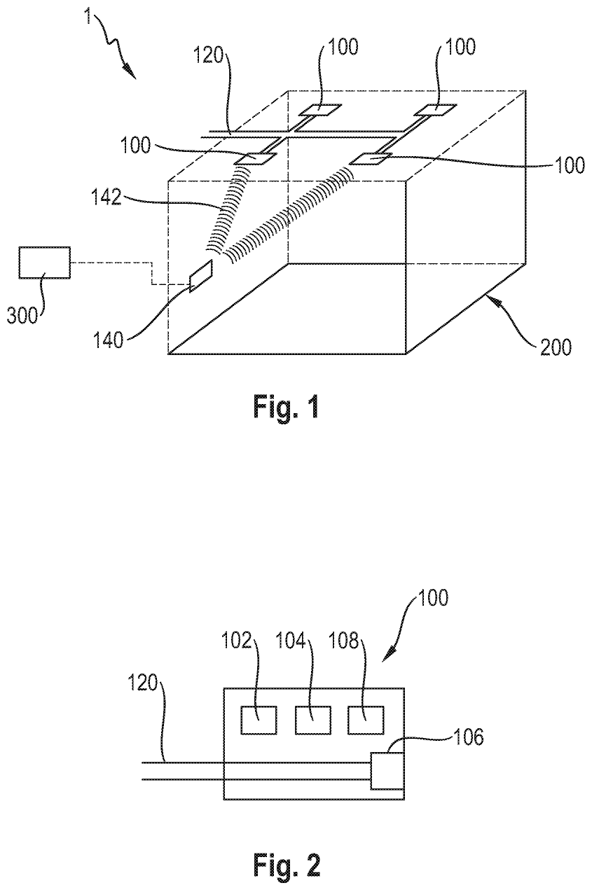

FIG. 1 shows, schematically and by way of example, a fire extinguishing installation 1 according to the invention for protecting, in particular for fighting a detected fire in, at least one protected area 200. The fire extinguishing installation 1 comprises a fluid line network with a fluid line 120 and multiple extinguishing nozzles 100 connected to the fluid line 120. In a preferred case, the fire extinguishing installation 1 also has sensor means, for example as part of the extinguishing nozzles 100, which sensor means are configured for detecting fires. The fire extinguishing installation 1 is then also designed for monitoring the one or more protected areas 200.

The extinguishing nozzle 100 is configured for receiving energy. In this exemplary embodiment, the extinguishing nozzle 100 is configured for receiving energy 142 from an energy transmitter 140. The energy transmitter 140 may for example be configured for transmitting electromagnetic energy in the form of light or the like. The energy transmitter 140 is optionally connected to a control unit 300, which centrally coordinates functions and triggering events of the fire extinguishing installation 1. The control unit 300 is for example formed as part of a fire detector and/or extinguishing control station, though may also comprise any other PLC or proprietary control unit.

Whereas, in the exemplary embodiment of FIG. 1, the energy 142 is transmitted from the energy transmitter 140 to the energy harvester 102, an alternative transmission of the energy 142 is also possible in other embodiments. For example, the energy 142 may be transmitted by means of the fluid line 120, for example by a flow of the fluid situated therein or an electrically conductive fluid.

FIG. 2 shows, schematically and by way of example, the extinguishing nozzle 100 in detail. The extinguishing nozzle 100 has an energy harvester 102, a communication unit 104, a control element 106 and an energy store 108. The energy harvester 102 is configured for receiving energy by means of energy harvesting. The energy harvested by the energy harvester 102 serves for the operation of the communication unit 104 and for the triggering of the control element 106. For this purpose, the harvested energy may be buffer-stored in the energy store 108 such that triggering of the control element 106, for example of a valve for opening the fluid line 120, is ensured at all times.

The energy harvester 102 may implement all forms of energy harvesting. For example, said energy harvester may, as shown by way of example in FIG. 1, receive energy 142 from an energy transmitter 140. The energy harvester 102 may however also harvest energy present in the fluid line 120, for example vibrations, flows or else electrical currents which flow in an extinguishing fluid or else the fluid line 120. This is possible for example if the fluid line 120 has a suitable coating.

The communication unit 104 is configured to communicate for example with the energy transmitter 140 or with a similar suitable communication receiver and/or communication transmitter in order, in the event of a fire, to effect a release of the extinguishing fluid by means of the control element 106. Optionally, the extinguishing nozzle 100 may additionally have sensor means for detecting a fire. A detected fire signal can then likewise be transmitted by means of the communication unit 104 for example to the energy transmitter 140 and then to the control unit 300. The communication unit 104 is also preferably configured to transmit fault and/or status messages, for example in the event of a fault identified by means of a facility for self-monitoring of the device functions of the extinguishing nozzle 100. In other examples, the communication unit 104 may also communicate status messages at regular or irregular intervals independently of identified faults.

Although a single protected area 200 is shown by way of example in FIG. 2, the fire extinguishing installation 1 according to the invention is likewise applicable to any number of protected areas. In particular, the splitting-up into protected areas allows selective firefighting only in the sub-area in which a fire or a risk of fire also actually exists. It is also additionally or alternatively possible for multiple fire areas/areas of risk to be combined, for example if one area poses a particular risk to the surrounding areas.

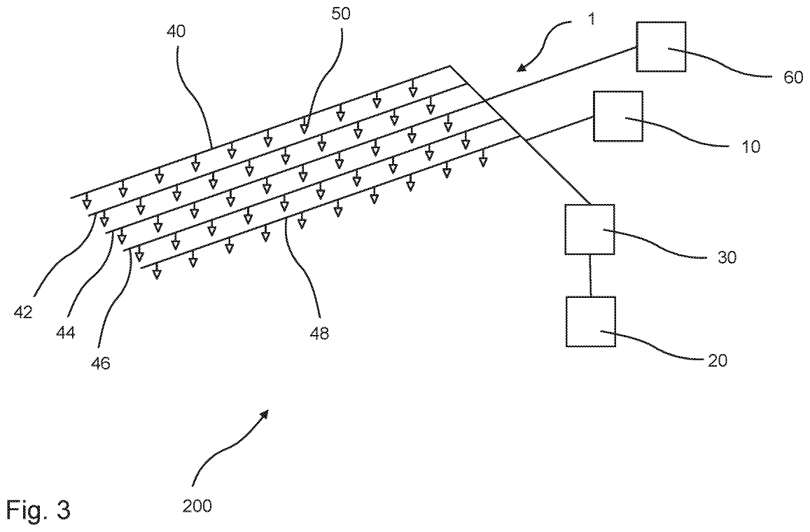

FIG. 3 shows, schematically and by way of example, a further configuration of a fire extinguishing installation 1, which can be combined with the embodiments of FIGS. 1 and 2.

The fire extinguishing installation 1 comprises a first extinguishing fluid line 40, a second extinguishing fluid line 42, a third extinguishing fluid line 44, a fourth extinguishing fluid line 46 and a fifth extinguishing fluid line 48, on each of which there are arranged multiple extinguishing devices in the form of sprinklers 50. By means of an extinguishing fluid pump 30, extinguishing fluid is, in the case of a triggering event, pumped from an extinguishing fluid source 20 through the first to fifth extinguishing fluid lines 40-48. As an alternative to the sprinkler 50, use may also be made of other extinguishing devices, for example extinguishing nozzles and in particular controllable extinguishing nozzles.

In this exemplary embodiment, each of the extinguishing fluid lines 40, 42, 44, 46, 48 is coupled to an energy source 10, wherein the extinguishing fluid line 40, 42, 44, 46, 48 itself allows the transmission of energy. This is therefore an electrically conductive extinguishing fluid line, whereby the need for separately implemented electrical connections to the sprinklers 50 is eliminated. The installation and maintenance outlay of the fire extinguishing installation 1 is thus reduced.

Each of the sprinklers 50 may have a dedicated control device 60, which may alternatively also be provided centrally for the entire fire extinguishing installation 1. The control device 60 can selectively effect a triggering of one or more of the sprinklers 50, or can alternatively or additionally also receive data from the individual sprinklers 50 and transmit said data for example to a fire detector and/or extinguishing control station. It is particularly preferable for one, multiple or all of the sprinklers 50 to comprise sensors such as temperature sensors or smoke sensors for this purpose.

The communication between sprinkler 50 and fire detector and/or extinguishing control station takes place preferably likewise via the extinguishing fluid line, wherein, preferably, the communication signal is superimposed onto the electrical voltage supply signal. Other communication channels, for example wireless communication channels, are also conceivable.

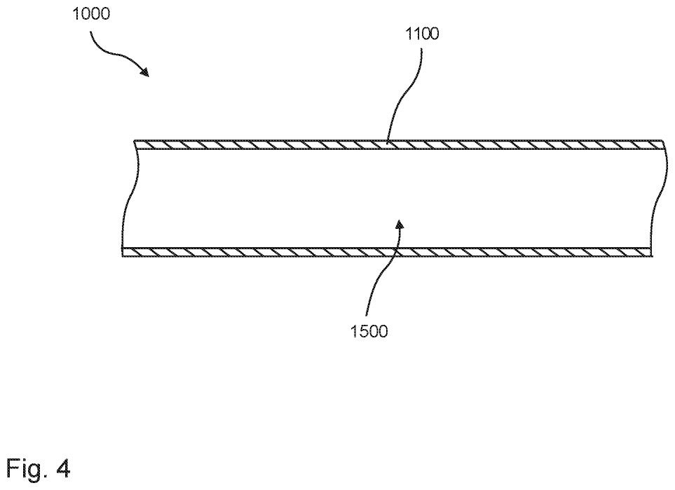

FIG. 4 shows, schematically and by way of example, a cross section of an extinguishing fluid line 1000 which is used for example as one of the extinguishing fluid lines 40-48 of FIG. 3. The extinguishing fluid line 1000 comprises a line conduit 1100 which is composed of an electrically conductive material or comprises an electrically conductive material and/or which is arranged and designed such that electrical energy can flow through the line conduit 1100. In the interior of the extinguishing fluid line 1000, there is a cavity 1500 in which the extinguishing fluid can flow.

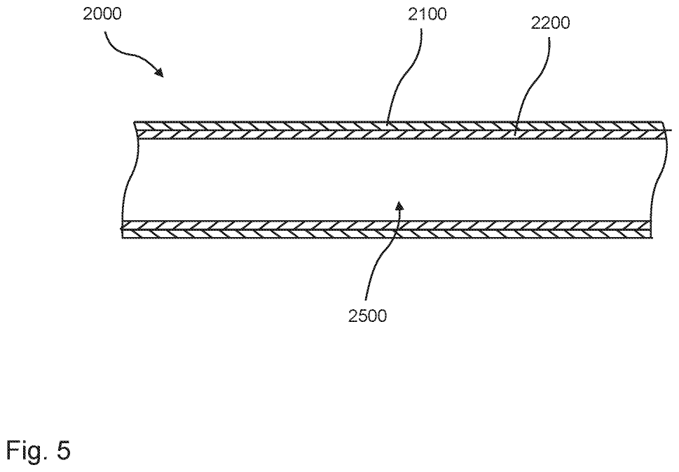

FIG. 5 shows, schematically and by way of example, a cross section of a further extinguishing fluid line 2000, which, in addition to a line conduit 2100 like the extinguishing fluid line 1000 shown in FIG. 4, has a conductive layer 2200, in particular a conductive coating. The conductive layer 2200 is composed of an electrically conductive material or comprises an electrically conductive material. The conductive layer 2200 is arranged on an outer circumferential surface and/or an inner circumferential surface of the line conduit 2100. The extinguishing fluid line 2000 is, in this example, arranged and designed to conduct electrical energy through the conductive layer 2200 to the extinguishing device. Preferably, in this case, the line conduit 2100 is composed of, or comprises, substantially electrically non-conductive material. In the interior of the extinguishing fluid line 2000, there is a cavity 2500 in which the extinguishing fluid can flow.

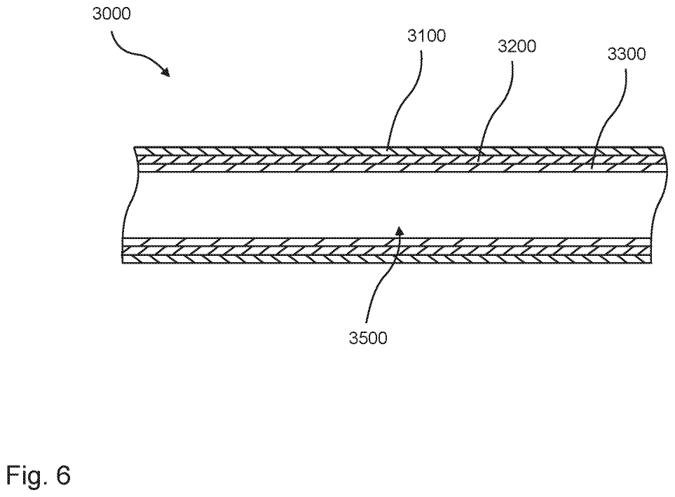

FIG. 6 shows, schematically and by way of example, a cross section of a further extinguishing fluid line 3000, which has an insulating layer 3300, in particular an insulating coating, and a conductive layer 3200. The conductive layer 3200 is arranged between a line conduit 3100, which was likewise comprised in the extinguishing fluid lines 1000 and 2000, and the insulating layer 3300 in a radial direction of the extinguishing fluid line 3000. The insulating layer 3300 is preferably arranged to the inside of the 3100 in a radial direction and/or the insulating layer 3300 is preferably arranged to the outside of the line conduit 3100 in a radial direction. In addition to the elements shown in FIG. 5 for the extinguishing fluid line 2000, the extinguishing fluid line 3000 accordingly comprises the insulating layer 3300. In the interior of the extinguishing fluid line 3000, there is a cavity 3500 in which the extinguishing fluid can flow.

### LIST OF UTILIZED REFERENCE NUMBERS

1 Fire extinguishing installation
5 Protected area
10 Energy source
20 Extinguishing fluid source
30 Extinguishing fluid pump
40 First extinguishing fluid line
42 Second extinguishing fluid line
44 Third extinguishing fluid line
46 Fourth extinguishing fluid line
48 Fifth extinguishing fluid line
50 Sprinkler
60 Control device
100 Extinguishing nozzle
102 Energy harvester
104 Communication unit
106 Control element
108 Energy store
120 Fluid line
140 Energy transmitter
142 Energy
200 Protected area
300 Control unit
1000 Extinguishing fluid line
1100 Line conduit
1500 Cavity
2000 Extinguishing fluid line
2100 Line conduit
2200 Conductive layer
2500 Cavity
3000 Extinguishing fluid line
3100 Line conduit
3200 Conductive layer
3300 Insulating layer
3500 Cavity

1. An extinguishing nozzle of a fire extinguishing installation for selectively identifying and fighting fires in at least one protected area, wherein the extinguishing nozzle comprising:
a communication unit which is configured for communicating with a control unit of the fire extinguishing installation,
a control element which is configured for controlling the extinguishing nozzle, wherein the extinguishing nozzle is connectable to at least one fluid line and the control element is configured for selectively enabling and/or shutting off a passage of an extinguishing fluid, which is flowing in the fluid line, through the extinguishing nozzle, and
an energy harvester which is configured for providing energy for at least the communication unit and the control element by energy harvesting.

2. The extinguishing nozzle as claimed in claim 1, wherein the energy harvester is configured to provide energy utilizing at least one of: a piezoelectric effect, a thermoelectric effect, an electromagnetic effect, a photoelectric effect and/or from a flow energy.

3. The extinguishing nozzle as claimed in claim 1, wherein the energy harvester is configured to receive and provide the energy from an energy transmitter which is provided for each protected area and which is configured for transmitting energy.

4. The extinguishing nozzle as claimed in claim 2, wherein the energy harvester has a piezo element.

5. The extinguishing nozzle as claimed in claim 2, wherein the energy harvester is configured to utilize a pressure or a change in the pressure within the fluid line for the purposes of providing energy.

6. The extinguishing nozzle as claimed in claim 2, wherein the energy harvester is configured to utilize a temperature or a flow through the fluid line for the purposes of providing energy.

7. The extinguishing nozzle as claimed in claim 1, wherein the energy harvester is configured to provide an electrical current, which is conducted by a fluid arranged within the fluid line, as energy.

8. The extinguishing nozzle as claimed in claim 2, wherein the energy harvester implements at least two different forms of energy harvesting.

9. The extinguishing nozzle as claimed in claim 1, which furthermore comprises an energy store which is configured to buffer-store energy provided by the energy harvester, wherein a capacity of the energy store is configured such that, in the event of failure of the energy harvester, reliable operation is ensured until the transmission of energy has been restored.

10. The extinguishing nozzle as claimed in claim 1, wherein the extinguishing nozzle comprises a controllable triggering arrangement with a housing and with a shut-off valve which is arranged in said housing and which is sealed off by a sealing element.

11. The extinguishing nozzle as claimed in claim 10, wherein the controllable triggering arrangement furthermore comprises a temperature-sensitive, destructible probe element, wherein
the temperature-sensitive destructible probe element is coupled to a thermal heating element, and
the heating element is equipped with outputs for connection to an energy store in conjunction with the control element.

12. A fire extinguishing installation for selectively identifying and fighting fires in at least one protected area, wherein the fire extinguishing installation comprises, for each protected area, one or more extinguishing nozzles as claimed in claim 1.

13. The fire extinguishing installation as claimed in claim 12, which furthermore comprises, for each protected area, an energy transmitter which is configured for transmitting energy to the one or more extinguishing nozzles.

14. The fire extinguishing installation as claimed in claim 13, wherein the energy transmitter comprises a communication connection to a control unit or a fire detector and/or an extinguishing control station, and is configured to communicate with the one or more extinguishing nozzles, wherein the communication of the extinguishing nozzles with the control unit takes place via the energy transmitter.

15. The fire extinguishing installation as claimed in claim 13, wherein the energy transmitter is configured to overlay or superimpose the communication with an energy receiver onto the transmitted energy.

16. The fire extinguishing installation as claimed in claim 13, wherein the transmitted energy comprises electromagnetic energy in the form of a targeted light beam or a targeted electromagnetic pulse.

17. The fire extinguishing installation as claimed in claim 12, which furthermore comprises at least one fluid line for providing extinguishing fluid at the one or more extinguishing nozzles, wherein
the fluid line is electrically insulated, and
the energy harvester is configured to provide electrical energy transmitted by an electrically conductive fluid within the fluid line.

18. The fire extinguishing installation as claimed in claim 12, wherein the activation of the extinguishing nozzles takes place automatically in the event of a communication failure.

19. A fire extinguishing system comprising a fire extinguishing installation as claimed in claim 12 and comprising a fire detector and/or an extinguishing control station.

20. A method for operating an extinguishing nozzle of a fire extinguishing installation for selectively identifying and fighting fires in at least one protected area, wherein the extinguishing nozzle comprises:
a communication unit which is configured for communicating with a fire detector and/or extinguishing control station of the fire extinguishing installation,
a control element which is configured for controlling the extinguishing nozzle, wherein the extinguishing nozzle is connectable to at least one fluid line and the control element is configured for selectively enabling and/or shutting off a passage of an extinguishing fluid, which is flowing in the fluid line, through the extinguishing nozzle, and
an energy harvester which is configured for providing energy for at least the communication unit and the control element by energy harvesting,
wherein the method comprises harvesting a provision of energy by the energy harvester.

21. The method as claimed in claim 20, wherein the method comprises a transmission of energy to the energy harvester of the extinguishing nozzle by an energy transmitter.

22. (canceled)
